(19) United States
(12) Patent Application Publication
(10) Pub. No.: US 2010/0014597 A1
(43) Pub. Date: Jan. 21, 2010

(54) Efficient apparatus for fast video edge filtering

(76) Inventor: John Gao, Coventry (GB)

Correspondence Address: FLYNN THIEL BOUTELL & TANIS, P.C., 2026 RAMBLING ROAD, KALAMAZOO, MI, 49008-1631, US

(21) Appl. No.: 12/387,233

(22) Filed: Apr. 29, 2009

(30) Foreign Application Priority Data
Apr. 29, 2008 (GB) 0807803.0

(51) Int. Cl. H04N 7/26

(52) U.S. Cl. 375/240.29; 375/E07.193

(57) ABSTRACT

A method and apparatus are provided for video edge filtering in which a buffer stores pixels required for edge filtering from a plurality of macroblocks. An input tile buffering unit comprising a plurality of dual port tile buffers receives tile portions of each macroblock. These are transposed selectively and provided to a programmable edge filter which performs one dimensional edge filtering on the tile portions. The filtered edges are then selectively transposed in a opposite manner to the first transpose unit and provided to an output buffer as well as provided back to the dual port tile buffers for use in further filtering.

### FIELD OF THE INVENTION

This invention relates to an efficient edge filtering apparatus for use in multi standard video compression and decompression.

### BACKGROUND TO THE INVENTION

In recent years digital video compression and decompression have been widely used in video related devices including digital TV, mobile phones, laptop and desktop computers, UMPC (ultra mobile PC), PMP (personal media player), PDA and DVD. In order to compress video, a number of video coding standards have been established, including H.263 by ITU (International Telecommunications Union), MPEG-2 and MPEG-4 by MPEG (Moving Picture Expert Group). Particularly the two latest video coding standards, H.264 by ITU and VC-1 by ISO/IEC (International Organization for Standardization/International Electrotechnical Commission), have been adopted as the video coding standards for next generation of high definition DVD, and HDTV in US, Europe and Japan. As all those standards are block based compression schemes, a new edge smoothing feature, called de-blocking is introduced in the two new video compression standards. In addition VC-1 also has an in-loop overlap transform for the block edge smoothing.

Picture compression is carried out by splitting a picture into non-overlapping 16×16 pixel macroblocks and encoding each of those 16×16 macroblocks sequentially. Because the human eye is less sensitive to chrominance than luminance, all video compression standards specify that in a colour picture the chrominance resolution is an half of the luminance resolution horizontally and vertically. So each of the colour macroblocks consists of a 16×16 luminance pixel block that is called Y block, and two 8×8 chrominance pixel blocks that are called Cb and Cr blocks,

In general each of the digital video pictures is encoded by removing redundancy in the temporal and spatial directions. Spatial redundancy reduction is performed by only encoding the intra picture residual data between a current macroblock and its intra predictive pixels. Intra predictive pixels are created by interpolation of the pixels from previously encoded macroblocks in a current picture. A picture with all intra-coded macroblock is called an I-picture.

Temporal redundancy reduction is performed by only encoding inter residual data between a current macroblock and corresponding inter predictive macroblock from another picture. An inter predictive macroblock is created by interpolation of the pixels from reference pictures that have been previously encoded. The amount of motion between a block within a current macroblock and a corresponding block in the reference picture is called a motion vector. Furthermore, an inter-coded picture with only forward reference pictures is called a P-picture, and an inter-coded picture with both forward and backward reference pictures is called a B-picture.

As the smallest sub-block in a coded macroblock is 4×4, a visible blocking artefact could occur in each of 4×4 block edges in a coded picture. In order to remove the inherent blocking artefact, de-blocking is performed inserted to the processing loop of an encoder or a decoder as shown in FIG. 1 and FIG. 2 respectively.

As shown in FIG. 1, a VC-1 encoder first obtains the best inter prediction from a reference picture by motion estimation, and compares this predition to an intra prediction mode. Then it encodes a current macroblock as either an intra macroblock or an inter macroblock. While encoding an intra macroblock, its transform coefficient residuals are encoded into the stream of data created. While encoding an inter macroblock, its motion vectors and pixel residuals are encoded into the stream.

As shown in FIG. 2, a VC-1 decoder first decodes the parameters and pixel residuals of every macroblock, and then obtains the intra or inter predictive blocks of every macroblock. Finally, decoded pixel residual blocks are added to corresponding predictive blocks and then de-blocked to form a final decoded picture. VC-1 also introduces another edge filter before de-blocking, called an overlap transform, to further smooth the edges between two 8×8 intra blocks in pictures. There is a local decoding loop in an encoder to create a decoded reference picture, so that both edge filters are also used in an encoder.

Within an interlaced video source, each of the frames (pictures) consists of two interlaced fields, a top (upper) field and a bottom (lower) field. Its top field consists of all even lines within the frame and its bottom field consists of all odd lines within the frame. A macroblock in an interlaced frame is shown in FIG. 3, 300 is its 16×16 Y block that can be split to two 16×8 Y field blocks, top field 16×8 Y block 300T and bottom field 16×8 Y block 300B. 310 is its two 8×8 Cb and Cr blocks.

To maximize compression efficiency either frame coding mode or field coding mode can be used to encode an interlaced frame in the picture layer and the macroblock layer. While the frame or field coding mode Is used in the picture layer, an interlaced frame is encoded as either a frame coded picture or two separate field coded pictures. Within a field coded picture, all macroblocks are field-coded macroblocks as all their pixels belong to the same field. But for a frame-coded picture, each of its macroblocks could be either frame-coded or field-coded. In the frame-coded macroblock, each of its 16×8 or 8×8 Y sub-blocks is frame based so that a half of its pixels belong to the top field and another half of its pixels belong to the bottom field. In contrast, in a field-coded macroblock, all pixels in each of its coded 16×8 or 8×8 Y sub-blocks belong to the same field, either a top field or a bottom field. The 8×8 Cb and Cr blocks are always treated as frame coded during the overlap transform and de-blocking.

The de-blocking edge filtering can be applied to each edge of all 4×4 frame blocks and all 4×4 field block within a coded picture. A frame edge is an edge between two 4×4 frame blocks as shown in 400 of FIG. 4 and a field edge is an edge between two 4×4 top or bottom field blocks as shown in 410 and 420 of FIG. 4. A frame block is a pixel block in which pixels in even lines belong to a top field and pixels in odd lines belong to a bottom field. A field block is a pixel block whose pixels belong to the same field, either a top field or a bottom field.

The de-blocking edge filtering in H.264 is applied to 4×4 block edges only. However, VC-1 also requires de-blocking edge filtering for horizontal edges of 4×2 field blocks in a frame coded interlaced picture because VC-1 de-blocking edge filtering is performed on a field basis and a 4×4 frame block edge effect can occur horizontally in its 4×2 top and 4×2 bottom field blocks which make up the 4×4 block. As specified in H.264 and VC-1, the de-blocking is an one dimensional edge smoothing filtering and requires up to 4 pixels in each side of an edge to derive the final results as shown in FIG. 5.

There is a requirement for different edge filtering orders: As shown in FIG. 6, the edge filtering order in H.264 de-blocking on a macroblock first filters the vertical edges from left to right followed by its horizontal edges filtering from top to bottom. Also in H.264 the de-blocking edge filtering is based on the macroblock coding type. The edge filtering of a frame coded macroblock is frame based so the two 4×4 blocks on both sides of an edge are frame blocks. The edge filtering of a field coded macroblock is field based so the two 4×4 blocks in both sides of an edge are field blocks. There is one exception for the horizontal macroblock edge between a field-coded upper macroblock and a frame-coded lower macroblock in which two horizontal edges should be filtered on a field basis, one edge from top field and another from the bottom field.

As shown in FIG. 7, unlike H.264, the VC-1 de-blocking edge filtering order in an interlaced frame is performed on a picture so that it first filters all horizontal edges in the picture from top to bottom followed by all vertical edges filtering from left to right Also VC-1 specifies that in an interlaced frame all de-blocking filtering is to be done by field basis so that the edge filtering process only uses the two blocks from the same field even if the macroblock is frame coded. As a result, macroblock de-blocking cannot be done until a lower macroblock in the field or frame is available, as some of the edge filtering requires pixels from the lower macroblock.

In high definition and multi-stream video encoding/decoding, simultaneous multiple line filtering is normally needed in de-blocking to meet speed demands. One solution is to employ multiple single-line programmable filtering engines in which the pipeline control complexity and silicon area are dramatically increased because of the intermediate data sharing requirement during de-blocking edge filtering and processing stalls that occur while required inputs from other edge filtering are not available.

With a single 4-line edge filtering engine, 4 line edge filtering can be performed in parallel. There are several reasons why data fetch and the edge ordering for such a multi-line filtering are complex. Firstly there are two different macroblock coding types in an interlaced frame, frame-coded and field-coded, so that the filtering requires either frame blocks or field blocks. Secondly, there are two types of the edges, horizontal or vertical. Thirdly there are different edge orders in different video standards. Finally some of the edge filtering requires the pixels from previous edge filtering so that those later edge filtering can be stalled if their required data is still being processed. Therefore there are requirements for fast multi-line pixel fetch and efficient edge filtering ordering in the multi-standard video de-blocking so that the edge filtering pipeline can be run fast and efficiently.

### SUMMARY OF THE INVENTION

Embodiments of the invention provide a single programmable edge filtering apparatus that is fast enough to process high definition interlaced video as shown in FIG. 8. An efficient interleaved tile storage approach is created so that two 4×4 field/frame blocks (for example) required for either horizontal or vertical edge filtering can be fetched by a single read or two reads from dual-port buffers 820. Also a programmable 4×4 pre-transpose unit 830 is used so that the 4-line edge filter 840 can deal with a horizontal and a vertical edge in the same way. A 4×4 post-transpose unit 850 is used to put the filtered blocks back to their original order and then put them back to the input dual-port buffer for further edge filtering as required. In addition, edge reordering is performed efficiently so that a 4×4 block are not reused until after a further predetermined number of reads from the dual-port buffers.

Preferably an efficient 4-line edge filtering apparatus is provided based on a local dual-port buffering unit with an interleaved video tile data storage format, two 4×4 transpose units and a single programmable 4-line edge filtering engine. This dramatically reduces the complexity of de-blocking and increase the speed of the data fetch required by progressive and interlaced video edge filtering for multi-standard video compression and decompression. The approach can be used for high definition video block edge filtering as performed by H.264 and VC-1 encoding and decoding.

For a progressive frame, all macroblocks are frame coded and all edges which require de-blocking are frame edges. The Y, Cb and Cr blocks in a macroblock are split into 4×4 blocks. Each of the 4×4 frame blocks forms a 16-pixel tile word in the two dual-port input buffers for the 4-line edge filter. As shown in FIG. 9, those 4×4 tiles are stored in two buffers so that each of the tiles in a buffer must have all its 4 adjacent tiles in another buffer. With such an interleaved data storage method, any of two 4×4 frame tiles on each side of either a horizontal or a vertical edge can be read from the two tile buffers by a single read.

As de-blocking of an interlaced frame is more complicated than for a progressive frame, the interlaced frame is first split a top field and a bottom field and then further split init to 4×2 field tiles for Y, Cb and Cr blocks. Each of the 4×2 field tiles is stored in one of the two dual-port input buffers for the 4-line edge filter. As shown in FIG. 10, those 4×2 field tiles are stored in two buffers so that each of the field tiles in a buffer must have its 4 adjacent field tiles in another buffer. Also for a top field 4×2 tile in a buffer, its corresponding bottom field 4×2 tile in the same location must be in another buffer. For an interlaced field-coded top or bottom field picture, the tile storage method is the same as top field tiles in a frame-coded picture as shown in 1010T of FIG. 10 for Y and 1020T of FIG. 10 for Cb and Cr. With such an interleaved data storage method, a 4×4 frame or field tile on one side of a horizontal/vertical frame or field edge can be taken from the two tile buffers by a single read.

In the de-blocking process, Y, Cb and Cr are processed independently. Also the top field and bottom field are filtered separately. While conforming to the orders specified in H.264 and VC-1, the edge filtering order can be reorganized by processing the edges in each of the independent planes in an interleaved order so that pipeline stalling can be reduced while some edge filtering waiting for the result from other edge filtering.

In accordance with one aspect of the present invention there is provided an apparatus for video edge filtering in a video signal in which images are subdivided into a plurality of macroblocks comprising a buffer storing all pixels required for edge filtering from a current macroblock and several adjacent macroblocks, an input tile buffering unit comprising a plurality of dual port buffers for receiving tile portions of each macroblock, a transpose unit for selectively transposing rows and columns of tile portions, a programmable edge filter for performing one dimensional vertical edge filtering, a second tile transpose unit for selectively transposing filtered edges in an opposite manner to the first tile transpose unit, and an output buffer to receive and store filtered data from each macroblock, and means for providing filtered tile portion data to replace existing tile portion data in the dual port buffers.

### BRIEF DESCRIPTION OF THE DRAWINGS

FIG. 1 shows a prior art encoder as described above;

FIG. 2 shows a prior art decoder as shown above;

FIG. 3 shows schematically a macroblock in an interlaced frame;

FIG. 4 shows the application of a deblocking edge filter to the various edges of the blocks;

FIG. 5 shows deblocking edge filtering applied to block edges;

FIG. 6 shows an edge filtering order in H.264 coding/decoding;

FIG. 7 shows an edge filtering order in VC-1 for an interlaced frame;

FIG. 8 shows an edge filtering apparatus embodying the invention;

FIG. 9 shows an array of tiles to be processed in an embodiment of the invention for a progressive scanned frame;

FIG. 10 shows tiles which have been processed in an embodiment of the invention for an interlaced frame;

FIG. 11 shows the arrangement of tiles from FIG. 10 in a buffer memory;

FIG. 12 shows the processing order in H.264 in an embodiment of the invention; and,

FIGS. 13 and 14 show second and third orders for deblocking in an embodiment of the invention.

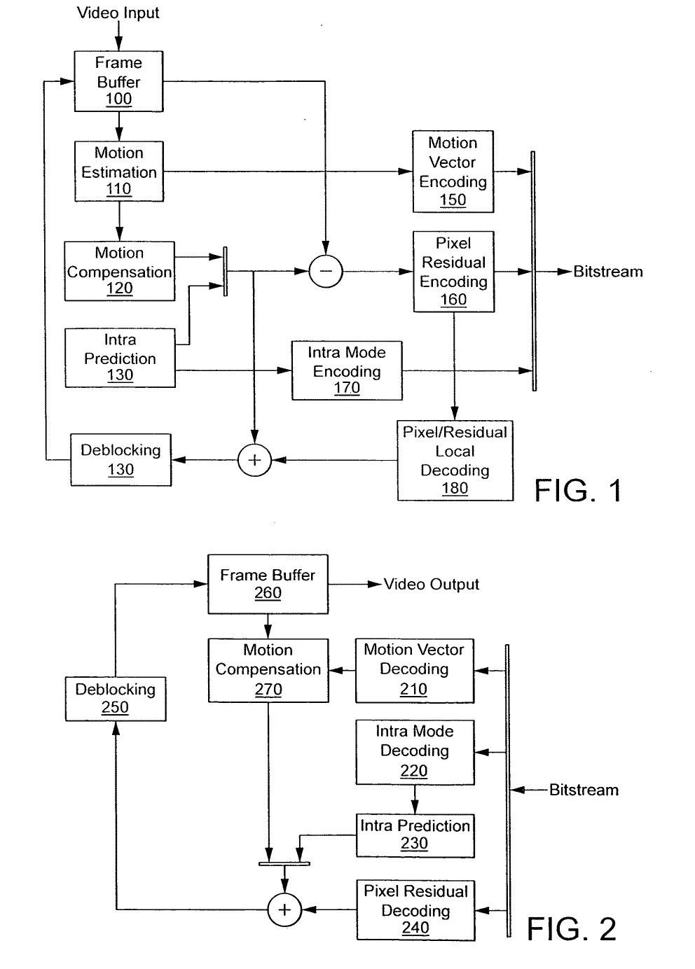

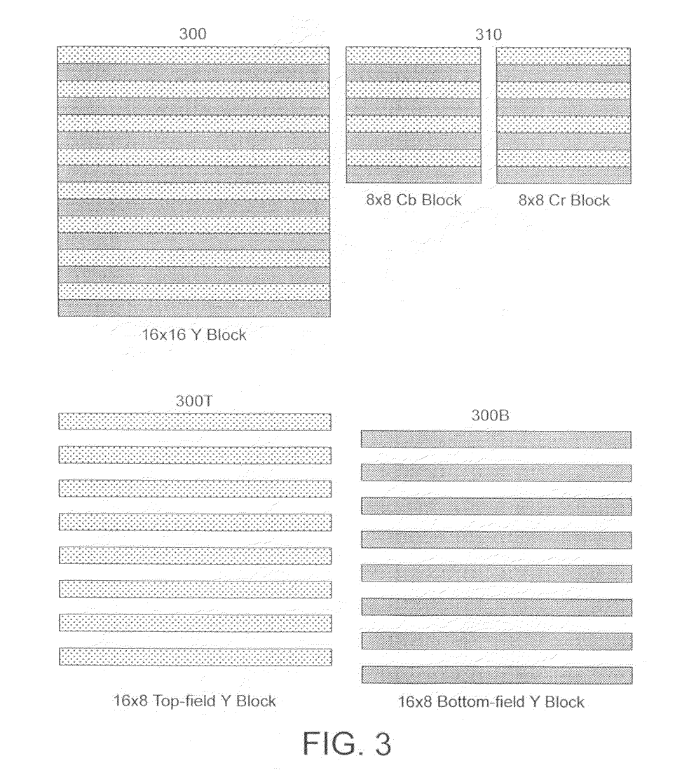

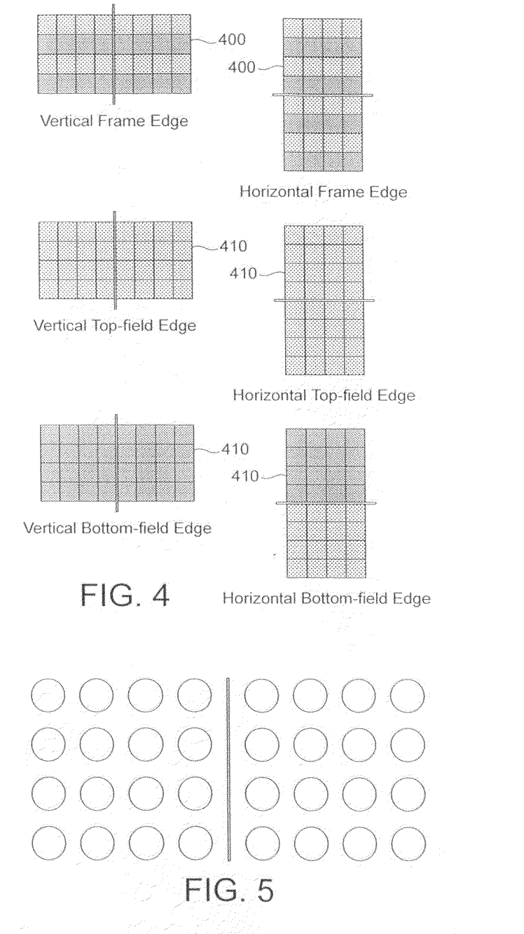

### DETAILED DESCRIPTION OF THE PREFERRED EMBODIMENTS

In the following example, apparatus embodying the invention is used to process an interlaced frame-coded picture to perform de-blocking in H.264 and VC-1. These are the most complex cases in H.264 and VC-1 video de-blocking.

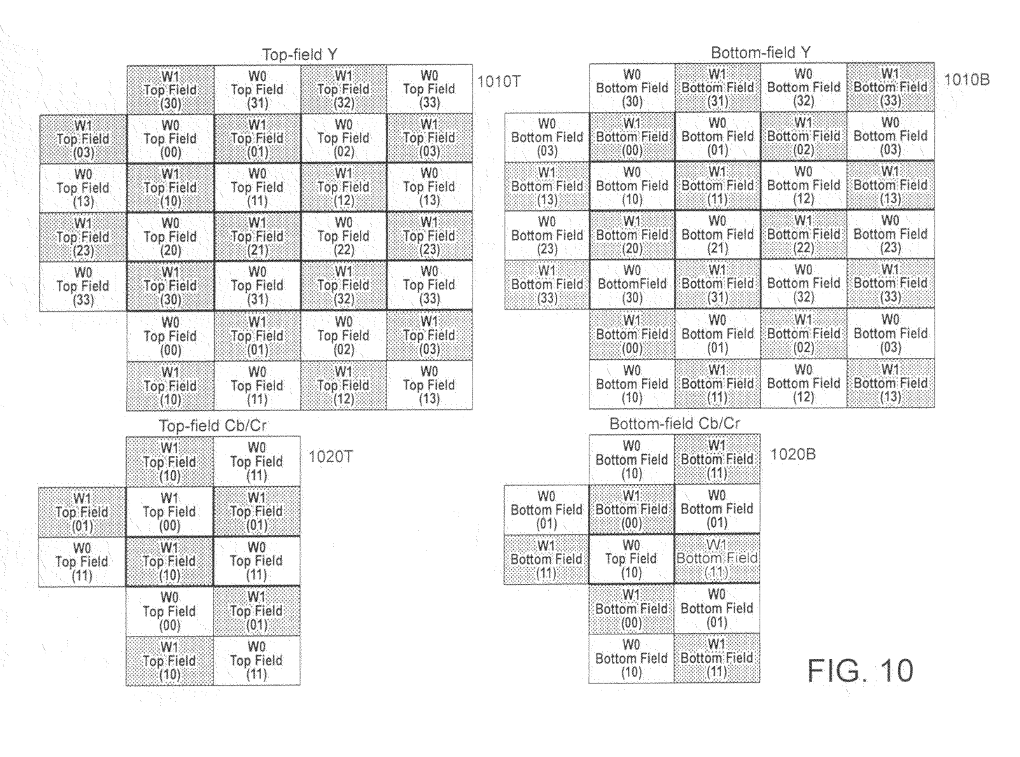

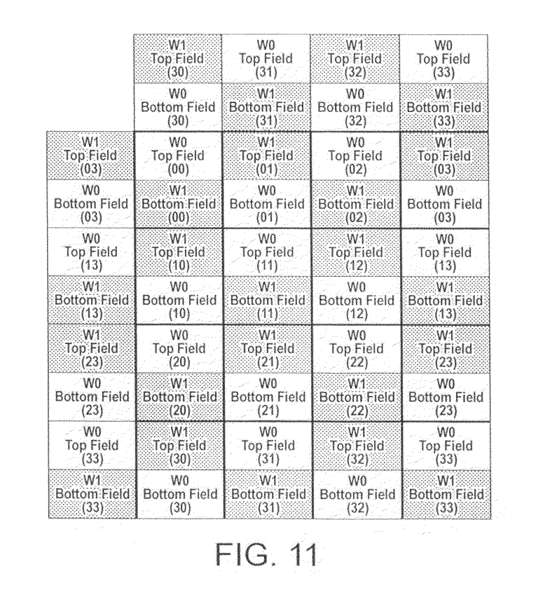

As shown in FIG. 10 each of the 8-pixel field words that contain a 4×2 field tile is stored in two dual-port buffers in interleaved format, all W0 words are in the buffer 0 and all W1 words are in the buffer 1. From 1010T and 1010B of FIG. 10, any of the 4×4 field Y blocks required by the de-blocking horizontal or vertical edge filtering process from either a top field or a bottom field can be read from those two buffers by only a single read. Similarly from 1020T and 1020B of FIG. 10, any of the 4×4 top or bottom field Cb/Cr blocks can be output from those two buffers by only a single read. In addition as shown in FIG. 11 any of the 4×4 frame blocks required by the de-blocking process can be fetched by a single read from the two buffers. Therefore only two reads are needed to obtain two 4×4 tiles for any frame or field for edge filtering in H.264 and VC-1 de-blocking.

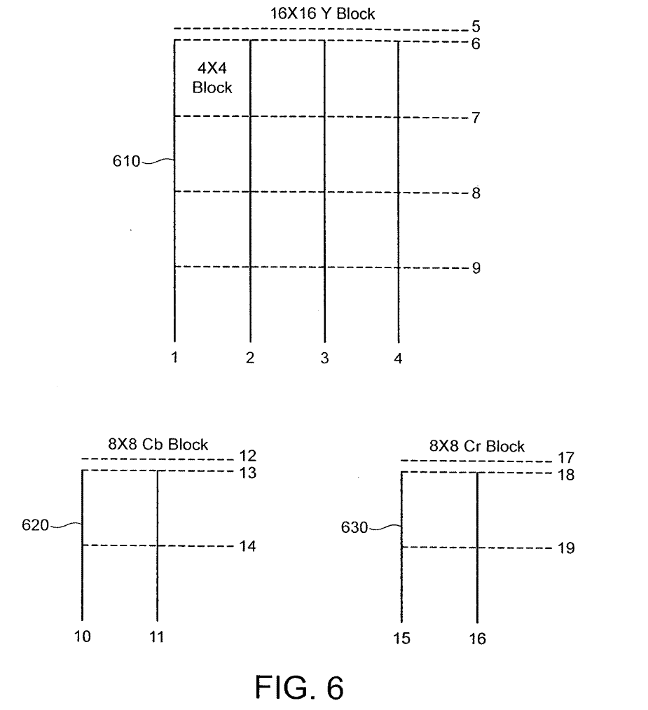

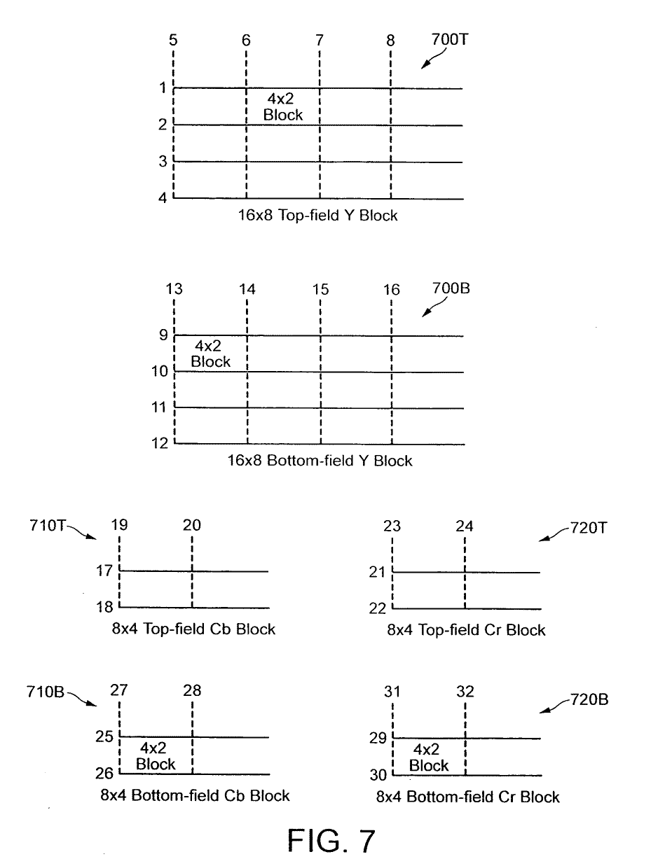

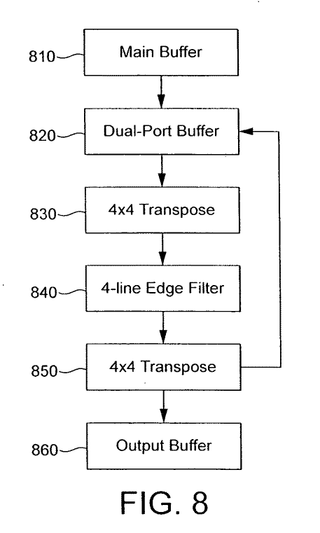

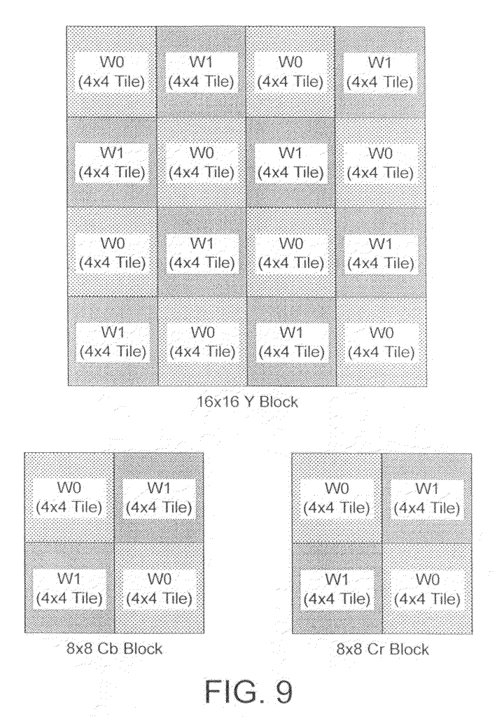

As the 4-line edge filter in this embodiment always processes a vertical edge, the two input 4×4 blocks for horizontal edge filtering have to be transposed before the filtering and transposed again after edge filtering to recover their original data order so that they can be sent back to the same location in the input buffers for further use of following edge filtering. Because the buffer is dual-port and requires one cycle per read, an edge can be input into the 4-line edge filter every two cycles. As shown in FIG. 6 and FIG. 7, there are up to 56 4-line edges in H.264 and up to 72 4-line edges in VC-1 which require edge filtering within a macroblock de-blocking process, so up to 112 cycles for H.264 and 144 cycles for VC-1 are needed for de-blocking a macroblock. Also extra time is required for sending pixel data from main buffer to the filtering input buffers.

As shown in FIG. 6, up to 48 4×4 tiles are required for a macroblock de-blocking in H.264, including 4 Y tiles, 2 Cb tiles and 2 Cr tiles from left, 8 Y tiles, 4 Cb tiles and 4 Cr tiles from above, 16 Y tiles, 4 Cb tiles and 4 Cr tiles from a current macroblock.

As shown in FIG. 7 and FIG. 10, up to 56 4×4 tiles are required for macroblock de-blocking in VC-1, including 4 Y tiles, 2 Cb tiles and 2 Cr tiles from left, 4 Y tiles, 2 Cb tiles and 2 Cr tiles from above, 8 Y tiles, 4 Cb tiles and 4 Cr tiles from below, 16 Y tiles, 4 Cb tiles and 4 Cr tiles from current macroblock. Without double buffering, if one tile is fetched per cycle then up to 48 cycles in H.264 and 56 cycles in VC-1 will be needed to input the required tiles from the main buffer to dual-port input buffers for a macroblock de-blocking.

In addition the number of buffers in a dual-port buffering unit can be doubled from two dual-port buffers to 4 dual-port buffers so that two 4×4 blocks can be output from the buffering unit by a single read while all the four buffers are used for edge filtering. Alternatively, the four dual-port buffers can be used for double buffering to reduce the loading time of new tiles so that two of the buffers work with the edge filter while the other two buffers are loading a new set of date for the next macroblock. Of course the pixels required from an immediately previous macroblock need to be loaded from a first set of two buffers to a second of two buffers before the edge filtering of the next macroblock, i.e. the data passes through the buffers sequentially and the process can be considered to be pipelined.

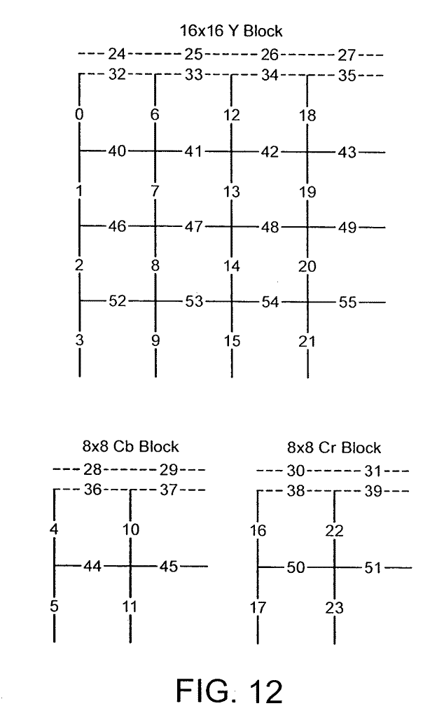

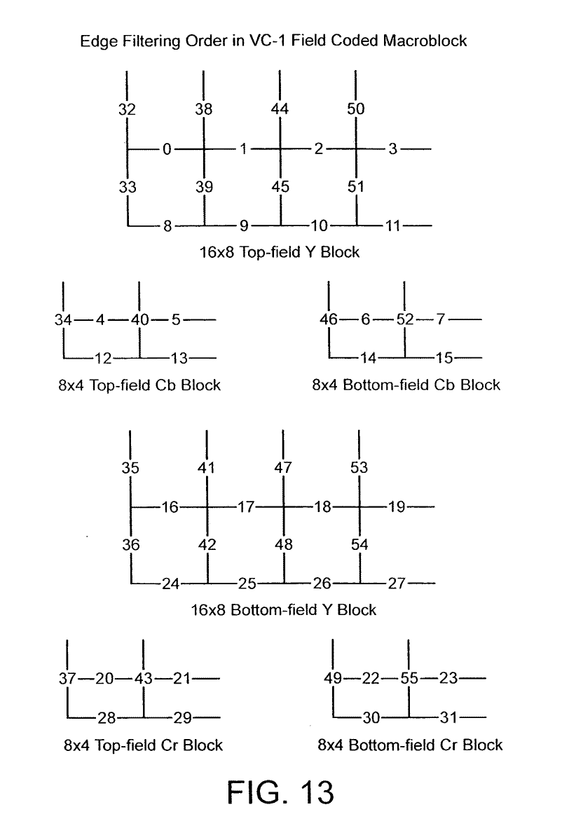

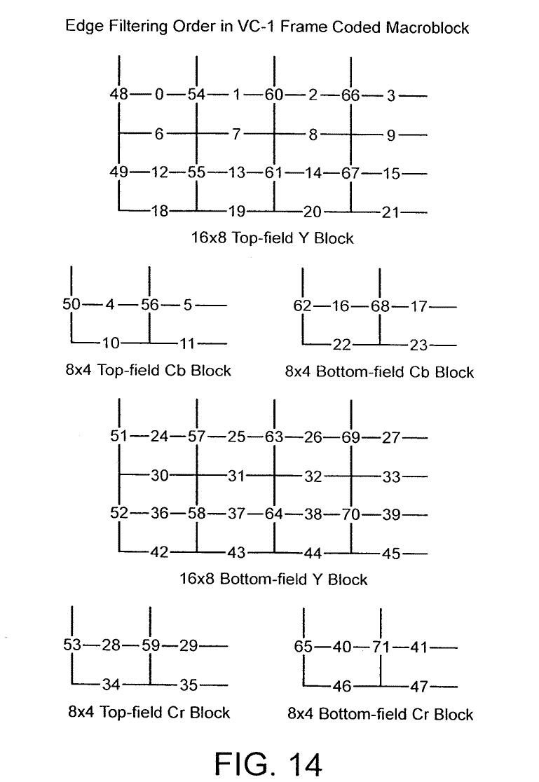

In order to obtain full speed from the processing pipeline with the minimum processing stalls between two consecutive edge filtering, the edge filtering is ordered in such a way that any following tile needed for edge filtering is available when needed. By using filtering independency of Y/Cb/Cr edges and top/bottom field edges, three different edge filtering orders in a frame-coded interlaced picture are created. The first order is for the de-blocking frame-coded macroblock in H.264 as shown in FIG. 12. The second and third orders are for de-blocking of frame-coded and field-coded macroblocks in VC-1 as shown in FIG. 13 and FIG. 14 respectively.

In FIG. 12, in H.264 there are up to 56 4-line edges to be filtered for a frame-coded macroblock with an upper field-coded macroblock. H.264 specifies that vertical edges are processed before the horizontal edges in a macroblock, so each of the 16-line vertical Y frame edges is followed by two 4-line Cr or Cb vertical frame edges. Similarly, each of the 16-line horizontal Y frame field edges is followed by two 4-line Cr or Cb horizontal frame edges. As there could be two horizontal field edges in the top macroblock boundary for Y, Cr and Cr to need to be filtered, the two field edges are processed one by one, thus the top field edge and the bottom field edge are filtered independently. As a result of the edge ordering, none 4×4 tiles cannot be reused until 6 edges have been processed.

From FIG. 13, in VC-1 there are up to 56 4-line edges to be filtered in a field-coded macroblock of a frame-coded interlaced picture. VC-1 specifies that its horizontal edges are processed before its vertical edges. As VC-1 de-blocking always uses field based filtering, filtering of each of its 16-line Y horizontal field edges Is followed by four 4-line Cr or Cb horizontal field edges. Similarly, filtering of each of its 8-line vertical field Y edges is followed by one 4-line Cr or Cb horizontal field edge. As a result, any 4×4 tile used in horizontal edge filtering cannot be reused until 8 edges have been processed, and any 4×4 tile used in vertical edge filtering cannot be reused until 6 edges have been processed.

From FIG. 14, in VC-1 there are up to 72 4-line edges to be filtered for a frame-coded macroblock. Its horizontal edges are processed before its vertical edges. As VC-1 de-blocking always uses field based filtering, each of its 16-line horizontal field Y edges is followed by two 4-line Cr or Cb horizontal field edges. Similarly each of its 8-line vertical Y field edges is followed by one 4-line Cr or Cb horizontal field edge. As a result, any 4×4 tile cannot be reused until the 6 edges have been processed.

Unlike H.264, VC-1 de-blocking always processes the upper macroblock, as the bottom horizontal edges of a macroblock need to be filtered during its de-blocking. As a result, VC-1 de-blocking is one row of macroblocks behind the rest of the block in an encoder/decoder. If an encoder/decoder doesn't accept the processing overlap of last row de-blocking in current picture and the first row of encode/decode in a next picture, a row of macroblock processing overhead occurs per picture.

1. Apparatus for video edge filtering in a video signal in which images are subdivided into a plurality of macroblocks comprising:
a main buffer storing pixels required for edge filtering from a plurality of macroblocks;
an input tile buffering unit comprising a plurality of dual-port tile buffers for receiving tile portions of each macroblock;
a transpose unit for selectively transposing rows and columns of input tile portions;
a programmable edge filter for performing one dimensional edge filtering;
a second tile transpose unit for selectively transposing filtered edges in an opposite manner to the first tile transpose unit;
an output buffer to receive and store filtered data from each macroblock; and
means for providing filtered data to the buffering unit.

2. Apparatus according to claim 1 in which the input tile buffering comprises two dual port tile buffers and the tile portions are stored alternatively in the two buffers such that two adjacent tile portions are each stored in different buffers.

3. Apparatus according to claim 1 in which the input tile buffering unit comprises 4 dual ports tile buffers.

4. Apparatus according to claim 1, in which an edge filtering order for tile portions filtering vertical edges before horizontal edges.

5. Apparatus according to claim 1, in which an edge filtering order for tile portions filters horizontal edges before vertical edges.

6. Apparatus according to claim 4 in which at least 5 edges are filtered after a first edge before tile portion data used for filtering the first edge is used again by the edge filtering.

7. A method for video edge filtering an a video signal in which images are subdivided into a plurality of macroblocks comprising buffering pixels required for edge filtering from a plurality of macroblocks;
further buffering tile portions of each macroblock in a plurality of dual-port tile buffers;
selectively transposing rows and columns of input tile portions;
performing one dimensional edge filtering on the selectively transposed input tile portions;
further selectively transposing the filtered edges in an opposite manner to the first transposing step;
buffering the filtered data for output; and
providing filtered tile portion data to replace existing tile portion data in the dual port tile buffers.

8. A method according to claim 7 in which the step of buffering the portions comprises storing the tile portions in alternate ones of two dual port tile buffers such that adjacent tile portions are stored in different dual port tile buffers.

9. A method according to claim 7 including the step of filtering at least 5 edges after filtering a first edge before reusing tile portion data used in filtering the first edge.
